(19) United States
(12) Patent Application Publication
(10) Pub. No.: US 2011/0050901 A1
(43) Pub. Date: Mar. 3, 2011

(54) TRANSMISSION APPARATUS AND PROCESSING APPARATUS

(75) Inventor: Takashi Oya, Yokohama-shi (JP)

(73) Assignee: CANON KABUSHIKI KAISHA, Tokyo (JP)

(21) Appl. No.: 12/872,847

(22) Filed: Aug. 31, 2010

(30) Foreign Application Priority Data
Sep. 2, 2009 (JP) 2009-202690

(51) Int. Cl. H04N 7/18

(52) U.S. Cl. 348/143; 348/E07.085

(57) ABSTRACT

A transmission apparatus includes an input unit configured to input an image, a detection unit configured to detect an object from the image input by the input unit, a generation unit configured to generate a plurality of types of attribute information about the object detected by the detection unit, a reception unit configured to receive a request, with which a type of the attribute information can be identified, from a processing apparatus via a network, and a transmission unit configured to transmit the attribute information of the type identified based on the request received by the reception unit, of the plurality of types of attribute information generated by the generation unit.

### BACKGROUND OF THE INVENTION

1. Field of the Invention

The present invention relates to a transmission apparatus and a processing apparatus.

2. Description of the Related Art

Recently, more and more monitoring systems use network cameras. A typical monitoring system includes a plurality of network cameras, a recording device that records images captured by the camera, and a viewer that reproduces live images and recorded images.

A network camera has a function for detecting an abnormal motion included in the captured images based on a result of image processing. If it is determined that an abnormal motion is included in the captured image, the network camera notifies the recording device and the viewer.

When the viewer receives a notification of an abnormal motion, the viewer displays a warning message. On the other hand, the recording device records the type and the time of occurrence of the abnormal motion. Furthermore, the recording device searches for the abnormal motion later. Moreover, the recording device reproduces the image including the abnormal motion.

In order to search for an image including an abnormal motion at a high speed, a conventional method records the occurrence of an abnormal motion and information about the presence or absence of an object as metadata at the same time as recording images. A method discussed in Japanese Patent No. 03461190 records attribute information, such as information about the position of a moving object and a circumscribed rectangle thereof together with images. Furthermore, when the captured images are reproduced, the conventional method displays the circumscribed rectangle for the moving object overlapped on the image. A method discussed in Japanese Patent Application Laid-Open No. 2002-262296 distributes information about a moving object as metadata.

On the other hand, in Universal Plug and Play (UPnP), which is a standard method for acquiring or controlling the status of a device via a network, a conventional method changes an attribute of a control target device from a control point, which is a control terminal. Furthermore, the conventional method acquires information about a change in an attribute of the control target device.

If a series of operations including detection of an object included in captured images, analysis of an abnormal state, and reporting of the abnormality is executed among a plurality of cameras and a processing apparatus, a vast amount of data is transmitted and received among apparatuses and devices included in the system. A camera included in a monitoring system detects the position and the moving speed of and the circumscribed rectangle for an object as object information. Furthermore, the object information to be detected by the camera may include information about a boundary between objects and other feature information. Accordingly, the size of object information may become very large.

However, necessary object information may differ according to the purpose of use of the system and the configuration of the devices or apparatuses included in the system. More specifically, not all pieces of object information detected by the camera may not be necessary.

Under these circumstances, because conventional methods transmit all pieces of object information detected by cameras to a processing apparatus, the cameras, network-connected apparatuses, and the processing apparatus are required to execute unnecessary processing. Therefore, high processing loads may arise on the cameras, the network-connected apparatuses, and the processing apparatus.

In order to solve the above-described problem, a method may seem useful that designates object attribute information, which is transmitted and received among cameras and a processing apparatus, as in UPnP. However, for image processing purposes, it is necessary that synchronization of updating of a status be securely executed. Accordingly, the above-described UPnP method, which asynchronously notifies the updating of each status, cannot solve the above-described problem.

### SUMMARY OF THE INVENTION

The present invention is directed to a transmission apparatus and a processing apparatus capable of executing processing at a high speed and reducing the load on a network.

According to an aspect of the present invention, a transmission apparatus includes an input unit configured to input an image, a detection unit configured to detect an object from the image input by the input unit, a generation unit configured to generate a plurality of types of attribute information about the object detected by the detection unit, a reception unit configured to receive a request, with which a type of the attribute information can be identified, from a processing apparatus via a network, and a transmission unit configured to transmit the attribute information of the type identified based on the request received by the reception unit, of the plurality of types of attribute information generated by the generation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary system configuration of a network system.

FIG. 2 illustrates an exemplary hardware configuration of a network camera.

FIG. 3 illustrates an exemplary functional configuration of the network camera.

FIG. 4 illustrates an exemplary functional configuration of a display device.

FIG. 5 illustrates an example of object information displayed by the display device.

FIGS. 6A and 6B are flow charts illustrating an example of processing for detecting an object.

FIG. 7 illustrates an example of metadata distributed from the network camera.

FIG. 8 illustrates an example of a setting parameter for a discrimination condition.

FIG. 9 illustrates an example of a method for changing a setting for analysis processing.

FIG. 10 illustrates an example of a method for designating scene metadata.

FIG. 11 illustrates an example of scene metadata expressed as extended Markup Language (XML) data.

FIG. 12 illustrates an exemplary flow of communication between the network camera and a processing apparatus (the display device).

FIG. 13 illustrates an example of a recording device.

FIG. 14 illustrates an example of a display of a result of object identification executed by the recording device.

FIG. 15 illustrates an example of scene metadata expressed in XML.

### DESCRIPTION OF THE EMBODIMENTS

Various exemplary embodiments, features, and aspects of the invention will be described in detail below with reference to the drawings.

In a first exemplary embodiment of the present invention, a network system will be described in detail below, which includes a network camera (a computer) configured to distribute metadata including information about an object included in an image to a processing apparatus (a computer), which is also included in the network system. The processing apparatus receives the metadata and analyzes and displays the received metadata.

The network camera changes a content of metadata to be distributed according to the type of processing executed by the processing apparatus. Metadata is an example of attribute information.

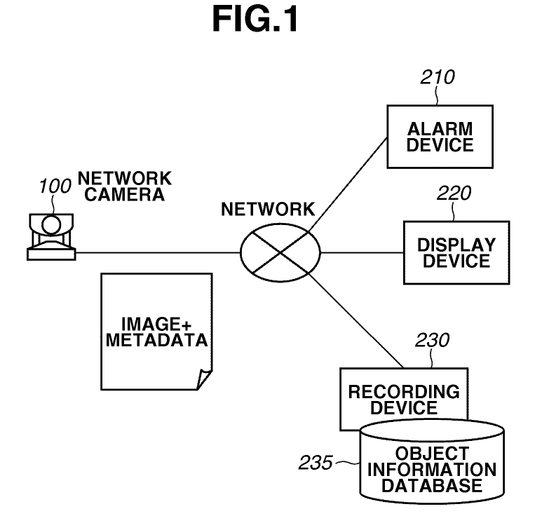

An example of a typical system configuration of the network system according to an exemplary embodiment of the present invention will be described in detail below with reference to FIG. 1. FIG. 1 illustrates an exemplary system configuration of the network system according to the present exemplary embodiment.

Referring to FIG. 1, the network system includes a network camera 100, an alarm device 210, a display device 220, and a recording device 230, which are in communication with one another via a network. Each of the alarm device 210, the display device 220, and the recording device 230 is an example of the processing apparatus.

The network camera 100 has a function for detecting an object and briefly discriminating the status of the detected object. In addition, the network camera 100 transmits various pieces of information including the object information as metadata together with captured images. As described below, the network camera 100 either adds the metadata to the captured images or distributes the metadata by stream distribution separately from the captured images.

The images and metadata are transmitted to the processing apparatuses, such as the alarm device 210, the display device 220, and the recording device 230. The processing apparatuses, by utilizing the captured images and the metadata, execute the display of an object frame on the image in an overlapping manner on the image, determination of the type of an object, and user authentication.

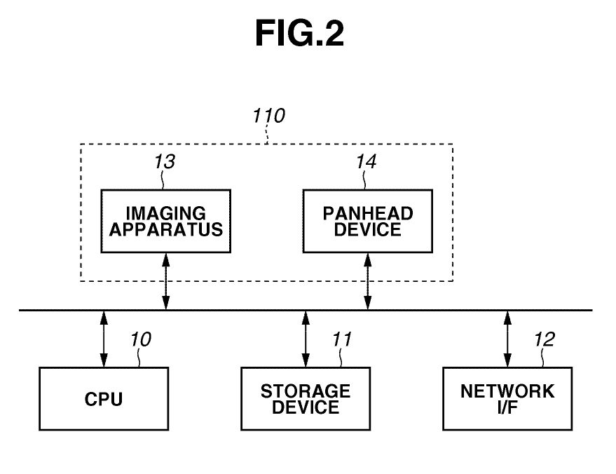

Now, an exemplary hardware configuration of the network camera 100 according to the present exemplary embodiment will be described in detail below with reference to FIG. 2. FIG. 2 illustrates an exemplary hardware configuration of the network camera 100.

Referring to FIG. 2, the network camera 100 includes a central processing unit (CPU) 10, a storage device 11, a network interface 12, an imaging apparatus 13, and a panhead device 14. As will be described below, the imaging apparatus 13 and the panhead device 14 are collectively referred to as an imaging apparatus and panhead device 110.

The CPU 10 controls the other components connected thereto via a bus. More specifically, the CPU 10 controls the panhead device 14 and the imaging apparatus 13 to capture an image of an object. The storage device 11 is a random access memory (RAM), a read-only memory (ROM), and/or a hard disk drive (HDD). The storage device 11 stores an image captured by the imaging apparatus 13, information, data, and a program necessary for processing described below. The network interface 12 is an interface that connects the network camera 100 to the network. The CPU 10 transmits an image and receives a request via the network interface 12.

In the present exemplary embodiment, the network camera 100 having the configuration illustrated in FIG. 2 will be described. However, the exemplary configuration illustrated in FIG. 2 can be separated into the imaging apparatus and the panhead device 110 and the other components (the CPU 10, the storage device 11, and the network interface 12).

If the network camera 100 has the separated configuration, a network camera can be used as the imaging apparatus and the panhead device 110 while a server apparatus can be used as the other components (the CPU 10, the storage device 11, and the network interface 12).

If the above-described separated configuration is employed, the network camera and the server apparatus are mutually connected via a predetermined interface. Furthermore, in this case, the server apparatus generates metadata described below based on images captured by the network camera. In addition, the server apparatus attaches the metadata to the images and transmits the metadata to the processing apparatus together with the images. If the above-described configuration is employed, the transmission apparatus corresponds to the server apparatus. On the other hand, if the configuration illustrated in FIG. 2 is employed, the transmission apparatus corresponds to the network camera 100.

A function of the network camera 100 and processing illustrated in flow charts described below are implemented by the CPU 10 by loading and executing a program stored on the storage device 11.

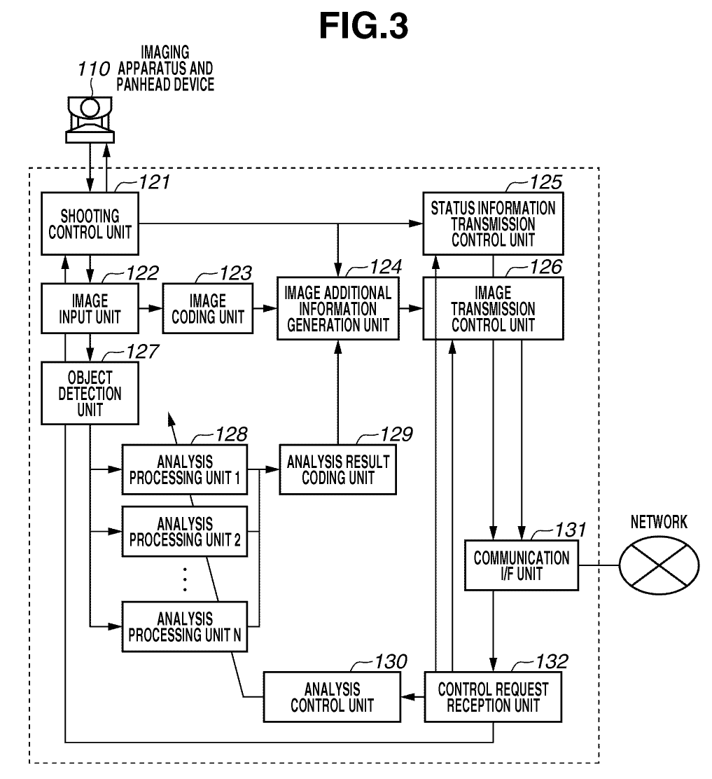

Now, an exemplary functional configuration of the network camera 100 (or the server apparatus described above) according to the present exemplary embodiment will be described in detail below with reference to FIG. 3. FIG. 3 illustrates an exemplary functional configuration of the network camera 100.

Referring to FIG. 3, a control request reception unit 132 receives a request for controlling panning, tilting, or zooming from the display device 220 via a communication interface (I/F) 131. The control request is then transmitted to a shooting control unit 121. The shooting control unit 121 controls the imaging apparatus and the panhead device 110.

On the other hand, the image is input to the image input unit 122 via the shooting control unit 121. Furthermore, the input image is coded by an image coding unit 123. For the method of coding by the image coding unit 123, it is useful to use a conventional method, such as Joint Photographic Experts Group (JPEG), Moving Picture Experts Group (MPEG)-2, MPEG-4, or H.264.

On the other hand, the input image is also transmitted to an object detection unit 127. The object detection unit 127 detects an object included in the images. In addition, an analysis processing unit 128 determines the status of the object and outputs status discrimination information. The analysis processing unit 128 is capable of executing a plurality of processes in parallel to one another.

The object information detected by the object detection unit 127 includes information, such as the position and the area (size) of the object, the circumscribed rectangle for the object, the age and the stability duration of the object, and the status of a region mask.

On the other hand, the status discrimination information, which is a result of the analysis by the processing unit 128, includes “entry”, “exit”, “desertion”, “carry-away”, and “passage”.

The control request reception unit 132 receives a request for a setting of object information about a detection target object and status discrimination information that is the target of analysis. Furthermore, an analysis control unit 130 analyzes the request. In addition, the control request reception unit 132 interprets a content to be changed, if any, and changes the setting of the object information about the detection target object and the status discrimination information that is the target of the analysis.

The object information and the status discrimination information are coded by a coding unit 129. The object information and the status discrimination information coded by the coding unit 129 are transmitted to an image additional information generation unit 124. The image additional information generation unit 124 adds the object information and the status discrimination information coded by the coding unit 129 to coded images. Furthermore, the images and the object information and the status discrimination information added thereto are distributed from an image transmission control unit 126 to the processing apparatus, such as the display device 220, via the communication I/F 131.

The processing apparatus transmits various requests, such as a request for controlling panning and tilting, a request for changing the setting of the analysis processing unit 128, and a request for distributing an image. The request can be transmitted and received by using a GET method in hypertext transport protocol (HTTP) or Simple Object Access Protocol (SOAP).

In transmitting and receiving a request, the communication I/F 131 is primarily used for a communication executed by Transmission Control Protocol/Internet Protocol (TCP/IP). The control request reception unit 132 is used for analyzing a syntax (parsing) of HTTP and SOAP. A reply to the camera control request is given via a status information transmission control unit 125.

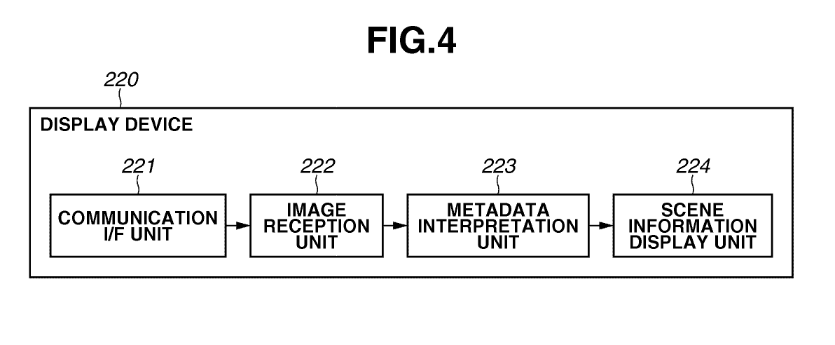

Now, an exemplary functional configuration of the display device 220 according to the present exemplary embodiment will be described in detail below with reference to FIG. 4. For the hardware configuration of the display device 220, the display device 220 includes a CPU, a storage device, and a display. The following functions of the display device 220 are implemented by the CPU by executing processing according to a program stored on the storage device.

FIG. 4 illustrates an exemplary functional configuration of the display device 220. The display device 220 includes a function for displaying the object information received from the network camera 100. Referring to FIG. 4, the display device 220 includes a communication I/F unit 221, an image reception unit 222, a metadata interpretation unit 223, and a scene information display unit 224 as the functional configuration thereof.

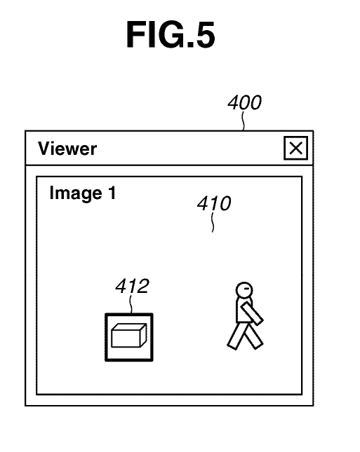

FIG. 5 illustrates an example of the status discrimination information displayed by the display device 220. FIG. 5 illustrates an example of one window on a screen. Referring to FIG. 5, the window includes a window frame 400 and an image display region 410. On the image displayed in the image display region 410, a frame 412, which indicates that an event of detecting desertion has occurred, is displayed.

The detection of desertion of an object according to the present exemplary embodiment includes two steps, i.e., detection of an object by the object detection unit 127 included in the network camera 100 (object extraction) and analysis by the analysis processing unit 128 of the status of the detected object (status discrimination).

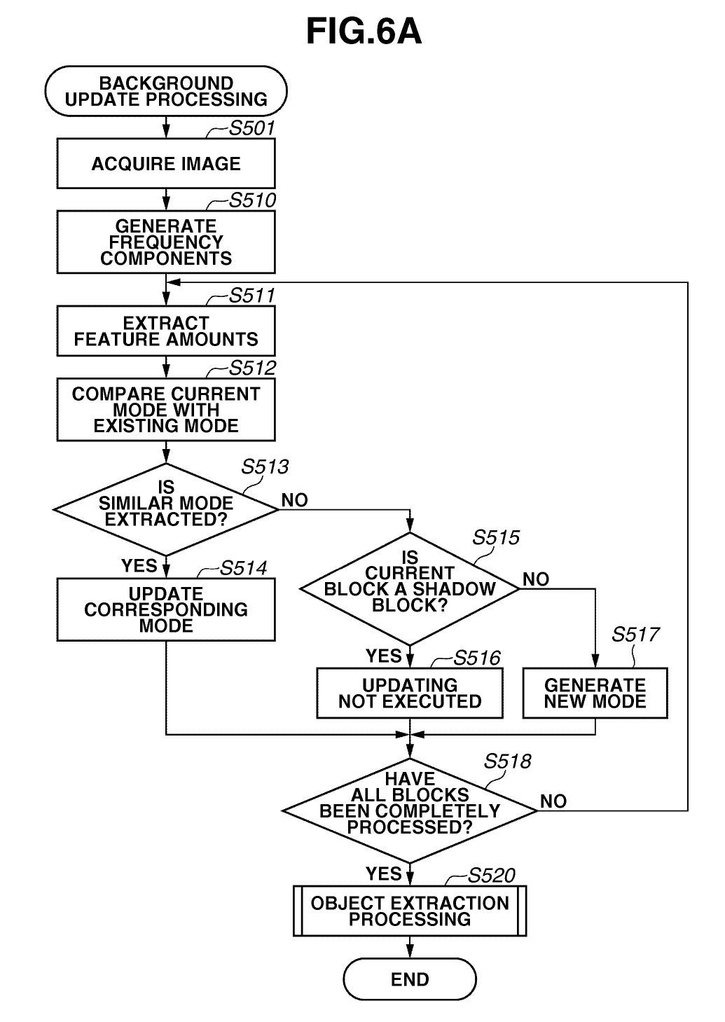

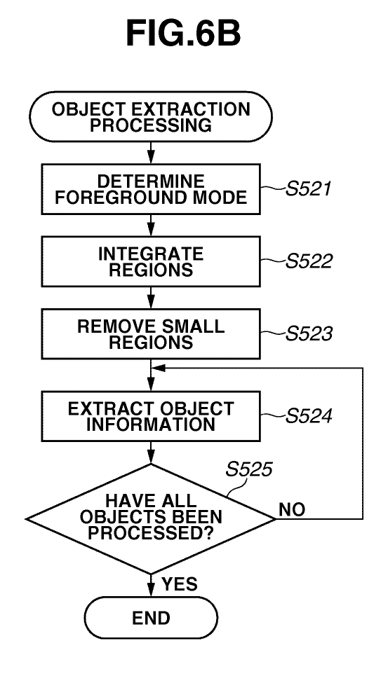

Exemplary object detection processing will be described in detail below with reference to FIGS. 6A and 6B. FIGS. 6A and 6B are flow charts illustrating an example of processing for detecting an object.

In detecting an object region, which is previously unknown, a background difference method is often used. The background difference method is a method for detecting an object by comparing a current image with a background model generated based on previously stored images.

In the present exemplary embodiment, a plurality of feature amounts, which is calculated based on a discrete cosine transform (DCT) component that has been subjected to DCT in the unit of a block and used in JPEG conversion, is utilized as the background model. For the feature amount, a sum of absolute values of DCT coefficients and a sum of differences between corresponding components included in mutually adjacent frames can be used. However, in the present exemplary embodiment, the feature amount is not limited to a specific feature amount.

Instead of using a method having a background model in the unit of a block, a conventional method discussed in Japanese Patent Application Laid-Open No. 10-255036, which has a density distribution in the unit of a pixel, can be used. In the present exemplary embodiment, either of the above-described methods can be used.

In the following description, it is supposed that the CPU 10 executes the following processing for easier understanding. Referring to FIGS. 6A and 6B, when background updating processing starts, in step S501, the CPU 10 acquires an image. In step S510, the CPU 10 generates frequency components (DCT coefficients).

In step S511, the CPU 10 extracts feature amounts (image feature amounts) from the frequency components. In step S512, the CPU 10 determines whether the plurality of feature amounts extracted in step S511 match an existing background model. In order to deal with a change in the background, the background model includes a plurality of states. This state is referred to as a “mode”.

Each mode stores the above-described plurality of feature amounts as one state of the background. The comparison with an original image is executed by calculation of differences between feature amount vectors.

In step S513, the CPU 10 determines whether a similar mode exists. If it is determined that a similar mode exists (YES in step S513), then the processing advances to step S514. In step S514, the CPU 10 updates the feature amount of the corresponding mode by mixing a new feature amount and an existing feature amount by a constant rate.

On the other hand, if it is determined that no similar mode exists (NO in step S513), then the processing advances to step S515. In step S515, the CPU 10 determines whether the block is a shadow block. The CPU 10 executes the above-described determination by determining whether a feature amount component depending on the luminance only, among the feature amounts, has not varied as a result of comparison (matching) with the existing mode.

If it is determined that the block is a shadow block (YES in step S515), then the processing advances to step S516. In step S516, the CPU 10 does not update the feature amount. On the other hand, if it is determined that the block is not a shadow block (NO in step S515), then the processing advances to step S517. In step S517, the CPU 10 generates a new mode.

After executing the processing in steps S514, S516, and S517, the processing advances to step S518. In step S518, the CPU 10 determines whether all blocks have been processed. If it is determined that all blocks have been processed (YES in step S518), then the processing advances to step S520. In step S520, the CPU 10 executes object extraction processing.

In steps S521 through S526 illustrated in FIG. 6B, the CPU 10 executes the object extraction processing. In step S521, the CPU 10 executes processing for determining whether a foreground mode is included in the plurality of modes with respect to each block. In step S522, the CPU 10 executes processing for integrating foreground blocks and generates a combined region.

In step S523, the CPU 10 removes a small region as noise. In step S524, the CPU 10 extracts object information from all objects. In step S525, the CPU 10 determines whether all objects have been processed. If it is determined that all objects have been processed, then the object extraction processing ends.

By executing the processing illustrated in FIGS. 6A and 6B, the present exemplary embodiment can constantly extract object information while serially updating the background model.

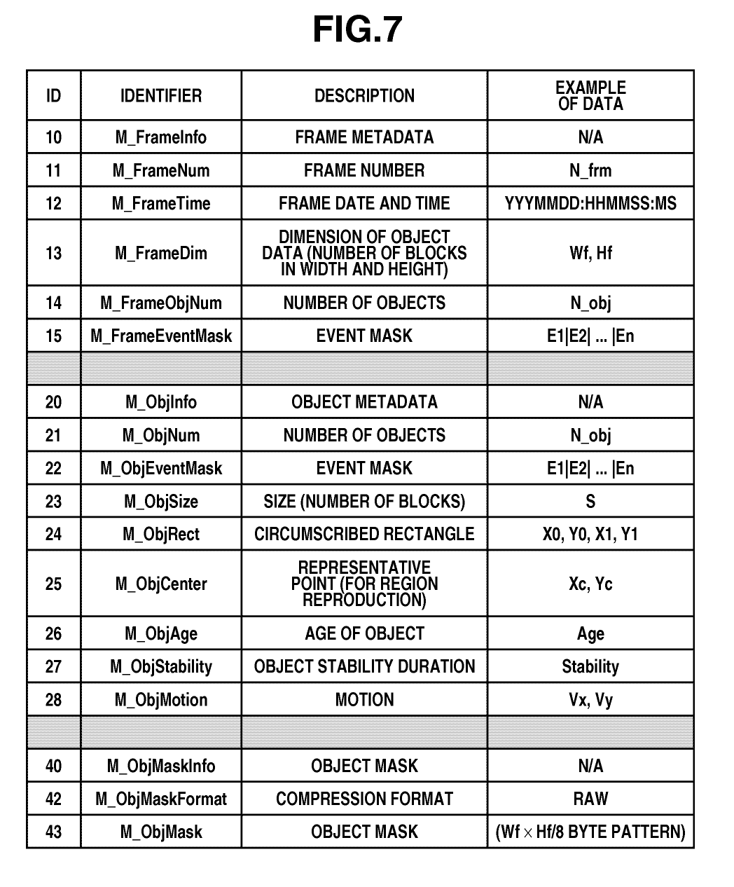

FIG. 7 illustrates an example of metadata distributed from the network camera. The metadata illustrated in FIG. 7 includes object information, status discrimination information about an object, and scene information, such as event information. Accordingly, the metadata illustrated in FIG. 7 is hereafter referred to as “scene metadata”.

In the example illustrated in FIG. 7, an identification (ID), an identifier used in designation as to the distribution of metadata, a description of the content of the metadata, and an example of data, which are provided for easier understanding, are described.

Scene information includes frame information, object information about an individual object, and object region mask information. The frame information includes IDs 10 through 15. More specifically, the frame information includes a frame number, a frame date and time, the dimension of object data (the number of blocks in width and height), and an event mask. The ID 10 corresponds to an identifier designated in distributing frame information in a lump.

An “event” indicates that an attribute value describing the state of an object satisfies a specific condition. An event includes “desertion”, “carry-away”, and “appearance”. An event mask indicates whether an event exists within a frame in the unit of a bit.

The object information includes IDs 20 through 28. The object information expresses data of each object. The object information includes “event mask”, “size”, “circumscribed rectangle”, “representative point”, “age”, “stability duration”, and “motion”.

The ID 20 corresponds to an identifier designated in distributing the object information in a lump. For the IDs 22 through 28, data exists for each object. The representative point (the ID 25) is a point indicating the position of the object. The center of mass can be used as the representative point. If object region mask information is expressed as one bit for one block as will be described below, the representative point is utilized as a starting point for searching for a region in order to identify a region of each object based on mask information.

The age (the ID 26) describes the elapsed time since the timing of generating a new foreground block included in an object. An average value or a median within a block to which the object belongs is used as a value of the age.

The stability duration (the ID 27) describes the rate of the length of time, of the age, for which a foreground block included in an object is determined to be a foreground. The motion (the ID 28) indicates the speed of motion of an object. More specifically, the motion can be calculated based on association with a closely existing object in a previous frame.

For detailed information about an object, the metadata includes object region mask data, which corresponds to IDs 40 through 43. The object detailed information represents an object region as a mask in the unit of a block.

The ID 40 corresponds to an identifier used in designating distribution of mask information. Information about a boundary of a region of an individual object is not recorded in the mask information. In order to identify a boundary between objects, the CPU 10 executes region division based on the representative point (the ID 25) of each object.

The above-described method is useful in the following point. More specifically, the data size is small because a mask of each object does not include label information. On the other hand, if objects are overlapped with one another, a boundary region cannot be correctly identified.

The ID 42 corresponds to a compression method. More specifically, the ID 42 indicates non-compressed data or a lossless compression method, such as run-length coding. The ID 43 corresponds to the body of a mask of an object, which normally includes one bit for one block. It is also useful if the body of an object mask includes one byte for one block by adding label information thereto. In this case, it becomes unnecessary to execute region division processing.

Now, event mask information (the status discrimination information) (the IDs 15 and 22) will be described. The ID 15 describes information about whether an event, such as desertion or carry-away, is included in a frame. On the other hand, the ID 22 describes information about whether the object is in the state of desertion or carry-away.

For both IDs 15 and 22, if a plurality of events exists, the events are expressed by a logical sum of corresponding bits. For a result of determination as to the state of desertion and carry-away, the result of analysis by the analysis processing unit 128 (FIG. 3) is used.

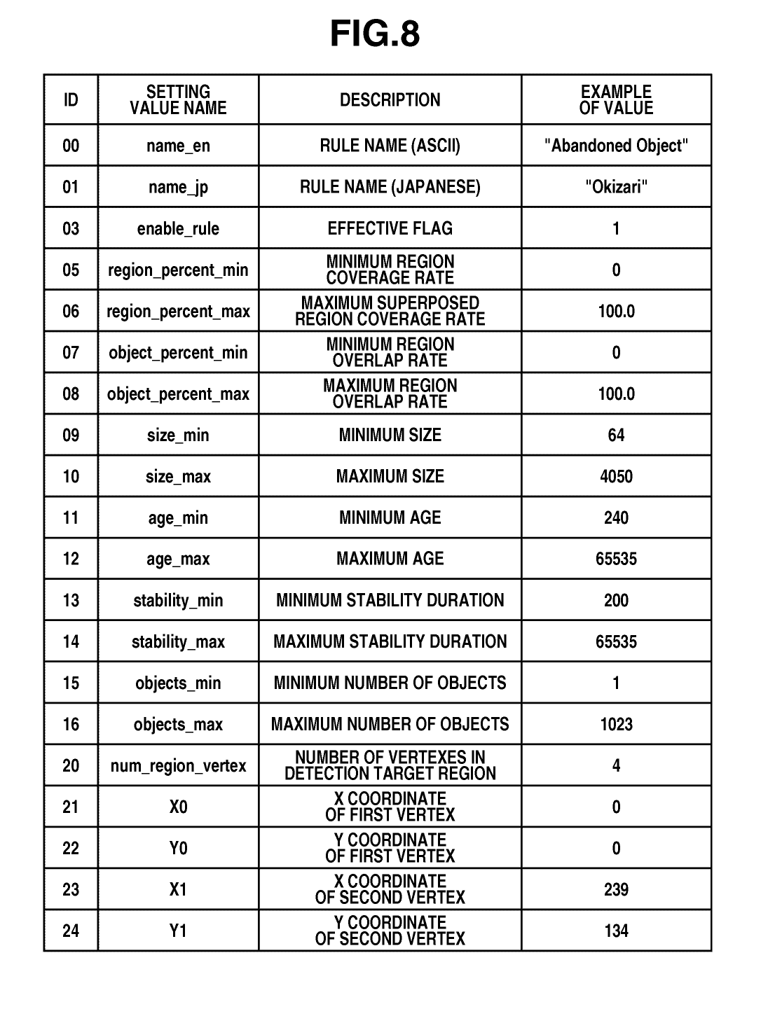

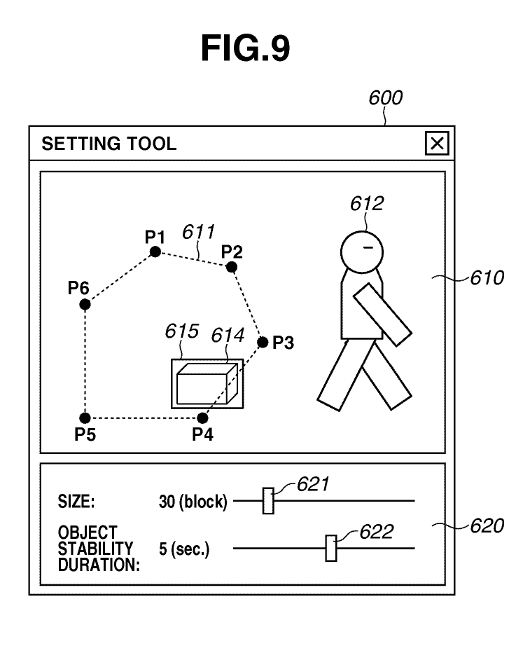

Now, an exemplary method of processing by the analysis processing unit 128 and a method for executing a setting for the analysis by the analysis processing unit 128 will be described in detail below with reference to FIGS. 8 and 9. The analysis processing unit 128 determines whether an attribute value of an object matches a discrimination condition.

FIG. 8 illustrates an example of a setting parameter for a discrimination condition. Referring to FIG. 8, an ID, a setting value name, a description of content, and a value (a setting value) are illustrated for easier understanding.

The parameters include a rule name (IDs 00 and 01), a valid flag (an ID 03), and a detection target region (IDs 20 through 24). A minimum value and a maximum value are set for a region coverage rate (IDs 05 and 06), an object overlap rate (IDs 07 and 08), a size (IDs 09 and 10), an age (IDs 11 and 12), and stability duration (IDs 13 and 14). In addition, a minimum value and a maximum value are also set for the number of objects within frame (IDs 15 and 16). The detection target region is expressed by a polygon.

Both the region coverage rate and the object overlap rate are rates expressed by a fraction using an area of overlapping of a detection target region and an object region as its numerator. More specifically, the region coverage rate is a rate of the above-described area of overlap on the area (size) of the detection target region. On the other hand, the object overlap rate is a rate of the size of the overlapped area to the area (size) of the object. By using the two parameters, the present exemplary embodiment can discriminate between desertion and carry-away.

FIG. 9 illustrates an example of a method for changing a setting for analysis processing. More specifically, FIG. 9 illustrates an example of a desertion event setting screen.

Referring to FIG. 9, an application window 600 includes an image display field 610 and a setting field 620. A detection target region is indicated by a polygon 611 in the image display field 610. The shape of the polygon 611, which indicates the detection target region, can be freely designated by adding, deleting, or changing a vertex P.

A user can execute an operation via the setting field 620 to set a minimum size value 621 of a desertion detection target object and a minimum stability duration value 622. The minimum size value 621 corresponds to the minimum size value (the ID 09) illustrated in FIG. 8. The minimum stability duration value 622 corresponds to the minimum stability duration value (the ID 13) illustrated in FIG. 8.

In order to detect a deserted object within a region, if any, the user can set a minimum value of the region coverage rate (the ID 05) by executing an operation via the setting screen. The other setting values may have a predetermined value. I.e., it is not necessary to change all the setting values.

The screen illustrated in FIG. 9 is displayed on the processing apparatus, such as the display device 220. The parameter setting values, which have been set on the processing apparatus via the screen illustrated in FIG. 9, can be transferred to the network camera 100 by using the GET method of HTTP.

In order to determine whether an object is in a “move-around” state, the CPU 10 uses the age and the stability duration as the basis of the determination. More specifically, if the age of an object having a size equal to or greater than a predetermined size is longer than predetermined time and if the stability duration thereof is shorter than predetermined time, then the CPU 10 can determine that the object is in the move-around state.

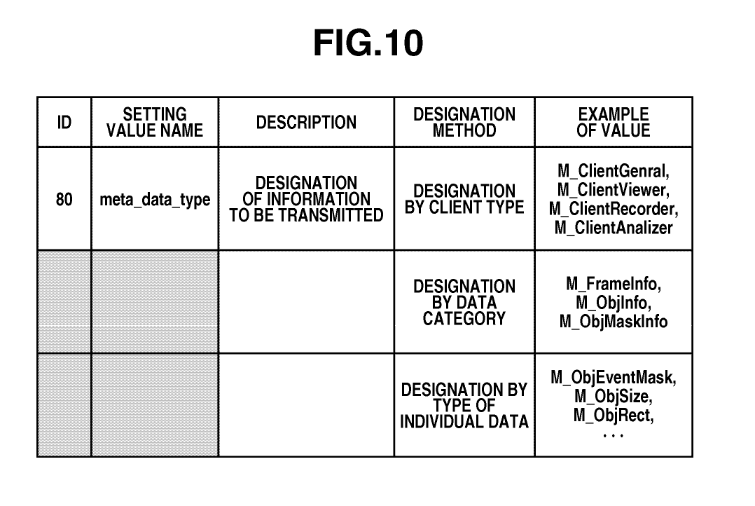

A method for designating scene metadata to be distributed will be described in detail below with reference to FIG. 10. FIG. 10 illustrates an example of a method for designating scene metadata. The designation is a kind of setting. Accordingly, in the example illustrated in FIG. 10, an ID, a setting value name, a description, a designation method, and an example of value are illustrated.

As described above with reference to FIG. 7, scene metadata includes frame information, object information, and object region mask information. For the above-described information, the user of each processing apparatus designates a content to be distributed via a setting screen (a designation screen) of each processing apparatus according to post-processing executed by the processing apparatuses 210 through 230.

The user can execute the setting for individual data. If this method is used, the processing apparatus designates individual scene information by designation by “M_ObjSize” and “M_ObjRect”, for example. In this case, the CPU 10 changes the scene metadata to be transmitted to the processing apparatus, from which the designation has been executed, according to the individually designated scene information. In addition, the CPU 10 transmits the changed scene metadata.

In addition, the user can also designate the data to be distributed by categories. More specifically, if this method is used, the processing apparatus designates the data in the unit of a category including data of individual scenes, by using a category, such as “M_FrameInfo”, “M_ObjectInfo”, or “M_ObjectMaskInfo”.

In this case, the CPU 10 changes the scene metadata to be transmitted to the processing apparatus, from which the above-described designation has been executed, based on the category including the individual designated scene data. In addition, the CPU 10 transmits the changed scene metadata.

Furthermore, the user can designate the data to be distributed by a client type. In this case, the data to be transmitted is determined based on the type of the client (the processing apparatus) that receives the data. If this method is used, the processing apparatus designates “viewer” (“M_ClientViewer”), “image recording server” (“M_ClientRecorder”), or “image analysis apparatus” (“M_CilentAanlizer”) as the client type.

In this case, the CPU 10 changes the scene metadata to be transmitted to the processing apparatus, from which the designation has been executed, according to the designated client type. In addition, the CPU 10 transmits the changed scene metadata.

If the client type is “viewer” and if an event mask and a circumscribed rectangle exist in the unit of an object, the display device 220 can execute the display illustrated in FIG. 5.

In the present exemplary embodiment, the client type “viewer” is a client type by which image analysis is not to be executed. Accordingly, in the present exemplary embodiment, if the network camera 100 has received information about the client type corresponding to the viewer that does not execute image analysis, then the network camera 100 transmits the event mask and the circumscribed rectangle as attribute information.

On the other hand, if the client type is “recording device”, then the network camera 100 transmits either one of the age and the stability duration of each object, in addition to the event mask and the circumscribed rectangle of each object, to the recording device. In the present exemplary embodiment, the “recording device” is a type of a client that executes image analysis.

On the network camera 100 according to the present exemplary embodiment, information about the association between the client type and the scene metadata to be transmitted is previously registered according to an input by the user. Furthermore, the user can generate a new client type. However, the present invention is not limited to this.

The above-described setting (designation) can be set to the network camera 100 from each processing apparatus by using the GET method of HTTP, similar to the event discrimination processing. Furthermore, the above-described setting can be dynamically changed during the distribution of metadata by the network camera 100.

Now, an exemplary method for distributing scene metadata will be described. In the present exemplary embodiment, scene metadata can be distributed separately from an image by expressing the scene metadata as XML data. Alternatively, if scene metadata is expressed as binary data, the scene metadata can be distributed as an attachment to an image. The former method is useful because if this method is used, an image and scene metadata can be separately distributed by different frame rates. On the other hand, the latter method is useful if JPEG coding method is used. Furthermore, the latter method is useful in a point that synchronization with scene metadata can be easily achieved.

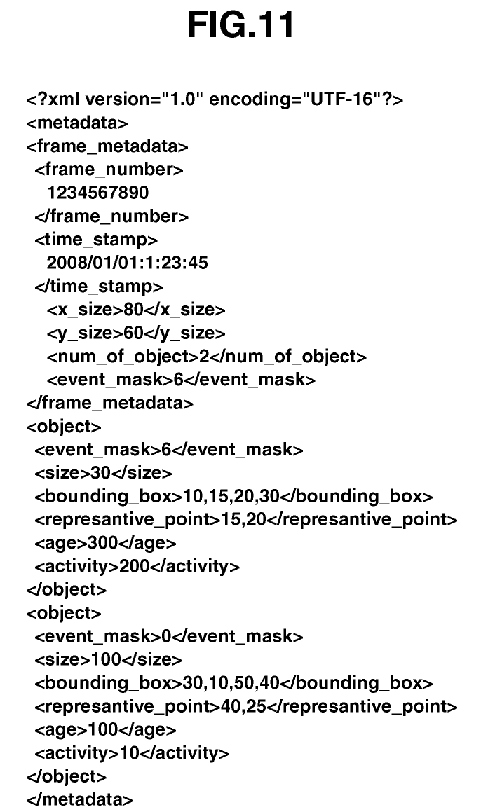

FIG. 11 (scene metadata example diagram 1) illustrates an example of scene metadata expressed as XML data. More specifically, the example illustrated in FIG. 11 expresses frame information and two pieces of object information of the scene metadata illustrated in FIG. 7. It is supposed that the scene metadata illustrated in FIG. 11 is distributed to the viewer illustrated in FIG. 5. If this scene metadata is used, a deserted object can be displayed on the data receiving apparatus by using a rectangle.

On the other hand, if scene metadata is expressed as binary data, the scene metadata can be transmitted as binary XML data. In this case, alternatively, the scene metadata can be transmitted as uniquely expressed data, in which the data illustrated in FIG. 7 is serially arranged therein.

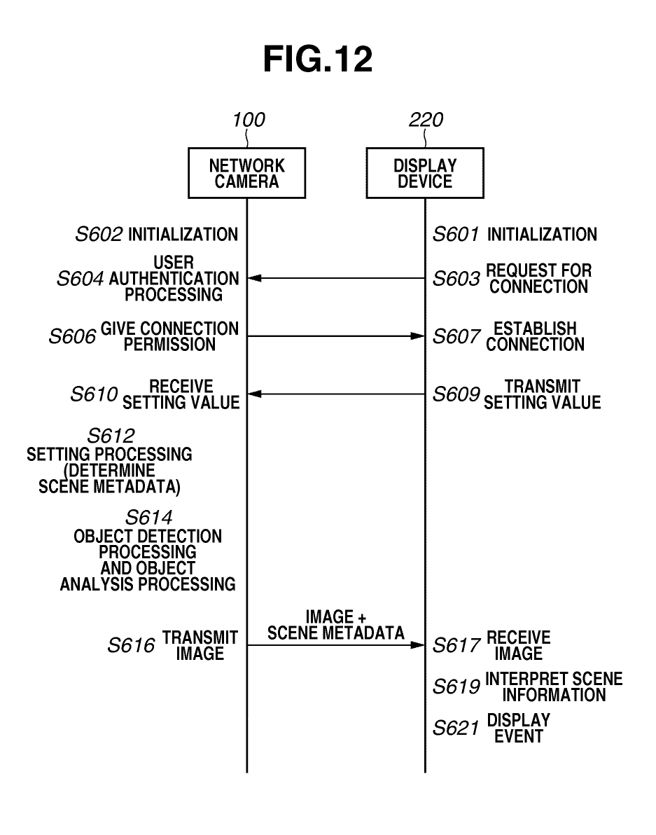

FIG. 12 illustrates an exemplary flow of communication between the network camera and the processing apparatus (the display device). Referring to FIG. 12, in step S602, the network camera 100 executes initialization processing. Then, the network camera 100 waits until a request is received.

On the other hand, in step S601, the display device 220 executes initialization processing. In step S603, the display device 220 gives a request for connecting to the network camera 100. The connection request includes a user name and a password. After receiving the connection request, in step S604, the network camera 100 executes user authentication according to the user name and the password included in the connection request. In step S606, the network camera 100 issues a permission for the requested connection.

As a result, in step S607, the display device 220 verifies that the connection has been established. In step S609, the display device 220 transmits a setting value (the content of data to be transmitted (distributed)) as a request for setting a rule for discriminating an event. On the other hand, in step S610, the network camera 100 receives the setting value. In step S612, the network camera 100 executes processing for setting a discrimination rule, such as a setting parameter for the discrimination condition, according to the received setting value. In the above-described manner, the scene metadata to be distributed can be determined.

More specifically, the control request reception unit 132 of the network camera 100 receives a request including the type of the attribute information (the object information and the status discrimination information). Furthermore, the status information transmission control unit 125 transmits the attribute information of the type identified based on the received request, of a plurality of types of attribute information that can be generated by the image additional information generation unit 124.

If the above-described preparation is completed, then the processing advances to step S614. In step S614, processing for detecting and analyzing an object starts. In step S616, the network camera 100 starts transmitting the image. In the present exemplary embodiment, scene information attached in a JPEG header is transmitted together with the image.

In step S617, the display device 220 receives the image. In step S619, the display device 200 interprets (executes processing on) the scene metadata (or the scene information). In step S621, the display device 220 displays a frame of the deserted object or displays a desertion event as illustrated in FIG. 5.

By executing the above-described method, the system including the network camera configured to distribute scene metadata, such as object information and event information included in an image and the processing apparatus configured to receive the scene metadata and execute various processing on the scene metadata changes the metadata to be distributed according to post-processing executed by the processing apparatus.

As a result, executing unnecessary processing can be avoided. Therefore, the speed of processing by the network camera and the processing apparatus can be increased. In addition, with the above-described configuration, the present exemplary embodiment can reduce the load on a network band.

A second exemplary embodiment of the present invention will be described in detail below. In the present exemplary embodiment, when the processing apparatus that receives data executes identification of a detected object and user authentication, object mask data is added to the scene metadata transmitted from the network camera 100, and the network camera 100 transmits the object mask data together with the scene metadata. With this configuration, the present exemplary embodiment can reduce the load of executing recognition processing executed by the processing apparatus.

A system configuration of the present exemplary embodiment is similar to that of the first exemplary embodiment described above. Accordingly, the detailed description thereof will not be repeated here. In the following description, a configuration different from that of the first exemplary embodiment will be primarily described.

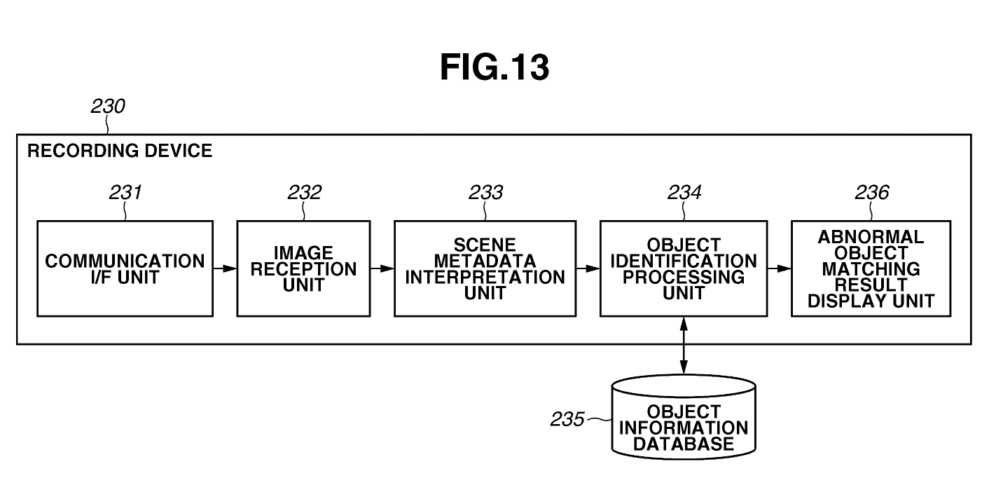

An exemplary configuration of the processing apparatus, which receives data, according to the present exemplary embodiment will be described with reference to FIG. 13. In the present exemplary embodiment, the recording device 230 includes a CPU, a storage device, and a display as a hardware configuration thereof. A function of the recording device 230, which will be described below, is implemented by the CPU by executing processing according to a program stored on the storage device.

FIG. 13 illustrates an example of a recording device 230. Referring to FIG. 13, the recording device 230 includes a communication I/F unit 231, an image reception unit 232, a scene metadata interpretation unit 233, an object identification processing unit 234, an object information database 235, and a matching result display unit 236. The recording device 230 has a function for receiving images transmitted from a plurality of network cameras and for determining whether a specific object is included in each of the received images.

Generally, in order to identify an object, a method for matching images or feature amounts extracted from images is used. In the present exemplary embodiment, the data receiving apparatus (the processing apparatus) includes the object identification function. This is because a sufficiently large capacity of an object information database cannot be secured in a restricted environment of installation of the system that is small for a large-size object information database.

As an example of an object identification function that implements object identification processing, a function for identifying the type of a detected stationary object (e.g., a box, a bag, a plastic (polyethylene terephthalate (PET)) bottle, clothes, a toy, an umbrella, or a magazine) is used. By using the above-described function, the present exemplary embodiment can issue an alert by prioritizing an object that is likely to contain dangerous goods or a hazardous material, such as a box, a bag, or a plastic bottle.

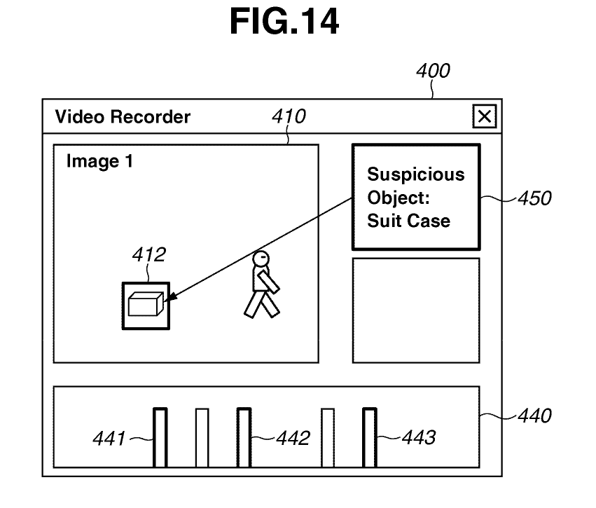

FIG. 14 illustrates an example of a display of a result of object identification executed by the recording device. In the example illustrated in FIG. 14, an example of a recording application is illustrated. Referring to FIG. 14, the recording application displays a window 400.

In the example illustrated in FIG. 14, a deserted object, which is surrounded by a frame 412, is detected in an image displayed in a field 410. In addition, an object recognition result 450 is displayed on the window 400. A timeline field 440 indicates the date and time of occurrence of an event. A right edge of the timeline field 440 indicates the current time. The displayed event shifts leftwards as the time elapses.

When the user designates the current time or past time, the recording device 230 reproduces images recorded by a selected camera starting with the image corresponding to the designated time. An event includes “start (or termination) of system”, “start (or end) of recording”, “variation of external sensor input status”, “variation of status of detected motion”, “entry of object”, “exit of object”, “desertion”, and “carry-away”. In the example illustrated in FIG. 14, an event 441 is illustrated as a rectangle. However, it is also useful if the event 441 is illustrated as a figure other than a rectangle.

In the present exemplary embodiment, the network camera 100 transmits object region mask information as scene metadata in addition to the configuration of the first exemplary embodiment. With this configuration, by using the object identification processing unit 234 that executes identification only on a region including an object, the present exemplary embodiment can reduce the processing load on the recording device 230. Because an object seldom takes a shape of a precise rectangle, the load on the recording device 230 can be more easily reduced if the region mask information is transmitted together with the scene metadata.

In the present exemplary embodiment, as a request for transmitting scene metadata, the recording device 230 designates object data (M_ObjInfo) and object mask data (M_OjbMaskInfo) as the data category illustrated in FIG. 10. Accordingly, the object data corresponding to the IDs 21 through 28 and object mask data corresponding to the IDs 42 and 43, of the object information illustrated in FIG. 7, is distributed.

In addition, in the present exemplary embodiment, the network camera 100 previously stores a correspondence table that stores the type of a data receiving apparatus and scene data to be transmitted. Furthermore, it is also useful if the recording device 230 designates a recorder (M_ClientRecorder) by executing the designation of the client type as illustrated in FIG. 10. In this case, the network camera 100 can transmit the object mask information.

For the format of the scene metadata to be distributed, either XML data or binary data can be distributed as the scene metadata as in the first exemplary embodiment.

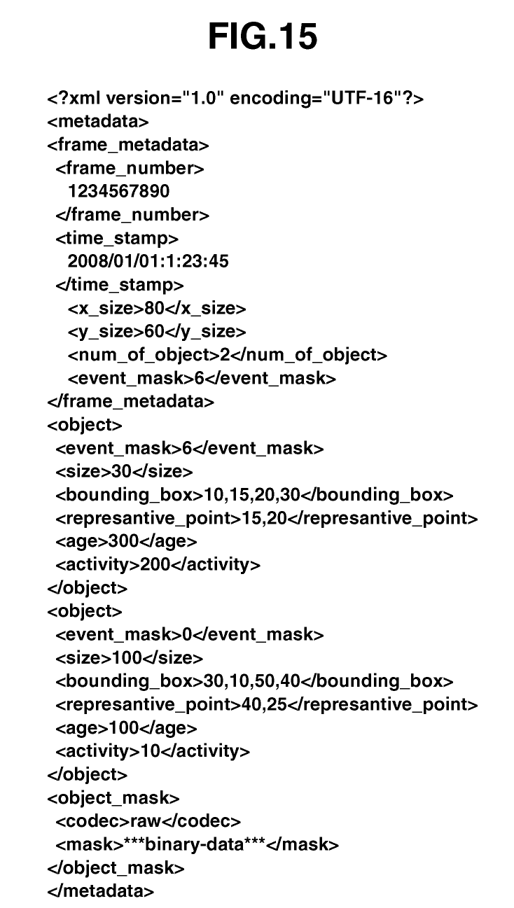

FIG. 15 (scene metadata example diagram 2) illustrates an example of scene metadata expressed as XML data. In the present exemplary embodiment, the scene metadata includes an <object_mask> tag in addition to the configuration illustrated in FIG. 11 according to the first exemplary embodiment. With the above-described configuration, the present exemplary embodiment distributes object mask data.

A third exemplary embodiment of the present invention will be described in detail below. In tracking an object or analyzing the behavior of a person included in the image on the processing apparatus, the tracking or the analysis can be efficiently executed if the network camera 100 transmits information about the speed of motion of the object and object mask information.

In analyzing the behavior of a person, it is necessary to extract a locus of the motion of the person by tracking the person. The locus extraction is executed by associating (matching) persons detected in different frames. In order to implement the person matching, it is useful to use speed information (M_ObjMotion).

In addition, a person matching method by template matching of images including persons can be employed. If this method is employed, the matching can be efficiently executed by utilizing information about a mask in a region of an object (M_ObjeMaskInfo).

In designating the metadata to be distributed, the metadata can be designated by individually designating metadata, by designating the metadata by the category thereof, of by designating the metadata by the type of the data receiving client as described above in the first exemplary embodiment.

If the metadata is to be designated by the client type, it is useful if the data receiving apparatus that analyzes the behavior of a person is expressed as “M_ClientAnalizer”. In this case, the data receiving apparatus is previously registered together with the combination of the scene metadata to be distributed.

As another exemplary configuration of the processing apparatus, it is also useful, if the user has not been appropriately authenticated as a result of face detection and face authentication by the notification destination, that the user authentication is executed according to information included in a database stored on the processing apparatus. In this case, it is useful if metadata describing the position of the face of the user, the size of the user's face, and the angle of the user's face is newly provided and distributed.

Furthermore, in this case, the processing apparatus refers to a face feature database, which is locally stored on the processing apparatus, to identify the person. If the above-described configuration is employed, the network camera 100 newly generates a category of metadata of user's face “M_FaceInfo”. In addition, the network camera 100 distributes information about the detected user's face, such as a frame for the user's face, “M_FaceRect” (coordinates of an upper-left corner and a lower left corner), vertical, horizontal, and in-plane angles of rotation within the captured image, “M_FacePitch”, “M_FaceYaw”, and “M_FaceRole”.

If the above-described configuration is employed, as a method of designating the scene metadata to be transmitted, the method for individually designating the metadata, the method for designating the metadata by the category thereof, or the method for using previously registered client type and the type of the necessary metadata can be employed as in the first exemplary embodiment. If the method for designating the metadata according to the client type is employed, the data receiving apparatus configured to execute face authentication is registered as “M_ClientFaceIdentificator”, for example.

By executing the above-described method, the network camera 100 distributes the scene metadata according to the content of processing by the client executed in analyzing the behavior of a person or executing face detection and face authentication. In the present exemplary embodiment having the above-described configuration, the processing executed by the client can be efficiently executed. As a result, the present exemplary embodiment can implement processing on a large number of detection target objects. Furthermore, the present exemplary embodiment having the above-described configuration can implement the processing at a high resolution. In addition, the present exemplary embodiment can implement the above-described processing by using a plurality of cameras.

According to each exemplary embodiment of the present invention described above, the processing speed can be increased and the load on the network can be reduced.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-202690 filed Sep. 2, 2009, which is hereby incorporated by reference herein in its entirety.

What is claimed is:

1. A transmission apparatus comprising:
an input unit configured to input an image;
a detection unit configured to detect an object from the image input by the input unit;
a generation unit configured to generate a plurality of types of attribute information about the object detected by the detection unit;
a reception unit configured to receive a request, with which a type of the attribute information can be identified, from a processing apparatus via a network; and
a transmission unit configured to transmit the attribute information of the type identified based on the request received by the reception unit, of the plurality of types of attribute information generated by the generation unit.

2. The transmission apparatus according to claim 1, wherein the attribute information includes at least one of region information indicating a region of the detected object within the image, a size of the detected object within the image, and an age of the detected object.

3. The transmission apparatus according to claim 1, further comprising a second detection unit configured to detect an occurrence of a predetermined event according to a positional relationship among a plurality of objects detected from a plurality of frames of the image,
wherein the attribute information includes event information indicating that the predetermined event has occurred.

4. The transmission apparatus according to claim 1, wherein the reception unit is configured to receive type information about a type of the processing apparatus as the request with which the type of the attribute information can be identified.

5. The transmission apparatus according to claim 4, wherein the transmission unit is configured, if the type information received by the reception unit is first type information, which indicates that the processing apparatus is a type of an apparatus that does not execute image analysis, to transmit region information that indicates a region in which each of the detected images exists within the image, while if the type information received by the reception unit is second type information, which indicates that the processing apparatus is a type of an apparatus that executes image analysis, the transmission unit is configured to transmit at least one of the age or stability duration of each object together with the region information about each of the detected objects.

6. The transmission apparatus according to claim 1, wherein the request received by the reception unit includes information about the type of the attribute information to be transmitted by the transmission unit.

7. The transmission apparatus according to claim 1, further comprising a storage unit configured to store association among the plurality of types of attribute information classified into categories,
wherein the request received by the reception unit includes information about the categories, and
wherein the transmission unit is configured to transmit the attribute information of the type associated with the category indicated by the request received by the reception unit.

8. A transmission method executed by a transmission apparatus, the transmission method comprising:
inputting an image;
detecting an object from the input image;
generating a plurality of types of attribute information about the detected object;
receiving a request, with which a type of the attribute information can be identified, from a processing apparatus via a network; and
transmitting the attribute information of the type identified based on the received request, of the plurality of types of generated attribute information.

9. The transmission method according to claim 8, further comprising receiving type information about a type of the processing apparatus as the request with which the type of the attribute information can be identified.

10. The transmission method according to claim 9, further comprising:
transmitting, if the received type information is first type information, which indicates that the processing apparatus is a type of an apparatus that does not execute image analysis, region information that indicates a region in which each of the detected images exists within the image; and
transmitting, if the received type information is second type information, which indicates that the processing apparatus is a type of an apparatus that executes image analysis, at least one of an age or stability duration of each object together with the region information about each of the detected objects.

11. The transmission method according to claim 8, wherein the received request includes information about the type of the attribute information to be transmitted.

12. The transmission method according to claim 8, further comprising:
storing association among the plurality of types of attribute information classified into categories, wherein the received request includes information about the categories; and
transmitting the attribute information of the type associated with the category indicated by the received request.

13. A computer-readable storage medium storing instructions which, when executed by a computer, cause the computer to perform operations comprising:
inputting an image;
detecting an object from the input image;
generating a plurality of types of attribute information about the detected object;
receiving a request, with which a type of the attribute information can be identified, from a processing apparatus via a network; and
transmitting the attribute information of the type identified based on the received request, of the plurality of types of generated attribute information.

14. The storage medium according to claim 13, wherein the operations further comprise receiving type information about a type of the processing apparatus as the request with which the type of the attribute information can be identified.

15. The storage medium according to claim 14, wherein the operations further comprise:
transmitting, if the received type information is first type information, which indicates that the processing apparatus is a type of an apparatus that does not execute image analysis, region information that indicates a region in which each of the detected images exists within the image; and
transmitting, if the received type information is second type information, which indicates that the processing apparatus is a type of an apparatus that executes image analysis, at least one of an age or stability duration of each object together with the region information about each of the detected objects.

16. The storage medium according to claim 13, wherein the received request includes information about the type of the attribute information to be transmitted.

17. The storage medium according to claim 13, wherein the operations further comprise:
storing association among the plurality of types of attribute information classified into categories, wherein the received request includes information about the categories; and
transmitting the attribute information of the type associated with the category indicated by the received request.
